(19) United States
(12) Patent Application Publication
(10) Pub. No.: US 2006/0109900 A1
(43) Pub. Date: May 25, 2006

(54) Image data transcoding

(76) Inventor: Bo Shen, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/996,123

(22) Filed: Nov. 23, 2004

(51) Int. Cl. H04N 11/04; H04B 1/66; H04N 7/12; H04N 11/02

(52) U.S. Cl. 375/240.03; 375/240.2; 375/240.24

(57) ABSTRACT

Various embodiments include a transcoder and a transcoding method, which combines an inverse-quantized DCT (discrete cosine transform) block with one or more transcoding matrices. The inverse-quantized DCT block represents image data compressed according to a first compression standard. A result is one or more transform coefficient matrices, which represent image data that is expandable according to a second compression standard.

### BACKGROUND

Video data is often compressed, using an encoding process, so that the data may be more efficiently stored or transmitted. At times, it may be desirable to process video data encoded using a first standard on hardware that processes video data encoded using a second standard. Accordingly, a conversion process may be employed to convert the video data from the first standard to the second standard. This may include decoding the video data that was encoded using the first standard, and re-encoding the resulting raw video data (e.g., pixel data) using the second standard. This process is referred to as “transcoding.”

In some cases, such as when the first standard and the second standard produce similarly formatted, encoded data, the transcoding process may be fairly straightforward, and may be achieved in real-time. However, in other cases, such as when the first standard and the second standard produce encoded data that is incompatibly-formatted, the transcoding process may be very complicated, consuming large amounts of computing power and rendering non-realtime transcoding results.

### BRIEF DESCRIPTION OF THE DRAWINGS

Like-reference numbers refer to similar items throughout the figures and:

FIG. 1 is a simplified block diagram of an image data processing system, in accordance with an example embodiment;

FIG. 2 is a diagram illustrating a layered format of an encoded video sequence;

FIG. 3 is a simplified block diagram of an image data transcoder apparatus, in accordance with an example embodiment;

FIG. 4 is a flowchart of a method for transcoding image data, in accordance with an example embodiment; and

FIG. 5 is a block diagram illustrating a 1×8 to 4×4 transcoding operation, in accordance with an example embodiment.

### DETAILED DESCRIPTION

The visual component of video basically consists of a series of images, which can be represented by image data (e.g., pixel data). Video or image data may be compressed according to a variety of compression standards, including but not limited to Motion Picture Experts Group versions 1, 2, and 4 (MPEG 1/2/4), H.261x (“x” indicates multiple versions), H.263x, and H.264x, to name a few. Each type of compression standard may operate on a different type of basic coding block, and may produce compressed data in a different format.

For example, but not by way of limitation, a first set of standards uses m-tap (e.g., m=8) discrete cosine transform (DCT) blocks as a basic coding block. This first set of standards includes, but is not limited to, MPEG 1/2/4, H.261x, H.263x, and the like. Conversely, a second set of standards uses n-tap (e.g., n=4) transform coefficient matrices (TCMs) as a basic coding block. This second set of standards includes, but is not limited to, H.264x, MPEG-4-AVC, and the like.

Because the type of basic coding block may vary from a first set of standards to a second set of standards, the compressed video or image data produced using the first set of standards may be significantly different from the compressed data produced using the second set of standards. Accordingly, equipment capable of decoding data compressed according to the first set of standards may be incapable of decoding data compressed according to the second set of standards, and vice versa. For example, in a teleconferencing system, a first teleconferencing station may capture video data, compress and encode the video data using the MPEG-2 standard, and send the encoded video data to a remote teleconferencing station for display. The remote teleconferencing station may be capable of interpreting H.264x compressed data, rather than MPEG-2 compressed data, and thus may be incapable of decoding and displaying the video.

Various embodiments include a transcoder and a transcoding method, which combines an inverse-quantized DCT block with one or more transcoding matrices. The inverse-quantized DCT block represents image data compressed according to a first compression standard. A result is one or more TCMs, which represent image data that is expandable according to a second compression standard.

Various embodiments include methods and apparatus for transcoding from quantized m-tap DCT blocks to quantized n-tap TCMs, where m may not equal n, and/or where m may be greater than n. For example, this may include transcoding from 8-tap (8×8) DCT blocks (e.g., from MPEG 1/2/4, H.261x, H.263x, and the like) to 4-tap (4×4) TCMs (e.g., to H.264x, MPEG-4-AVC, and the like). In a first embodiment, described below, an 8×8 DCT block (e.g., an MPEG 1/2/4, H.261 or H.263 block) may be transcoded to four 4×4 TCMs (e.g., H.264 blocks). In another embodiment, described below, an 8×8 DCT block may be transcoded to one 4×4 TCM to achieve resolution reduction, for example.

Embodiments may be implemented in a variety of different types of systems and apparatus. Although an example of an implementation within a video conferencing system is described, below, it should be understood that embodiments may be implemented in a wide variety of other types of systems and devices. Accordingly, implementations in other systems and devices are intended to fall within the scope of the disclosed subject matter.

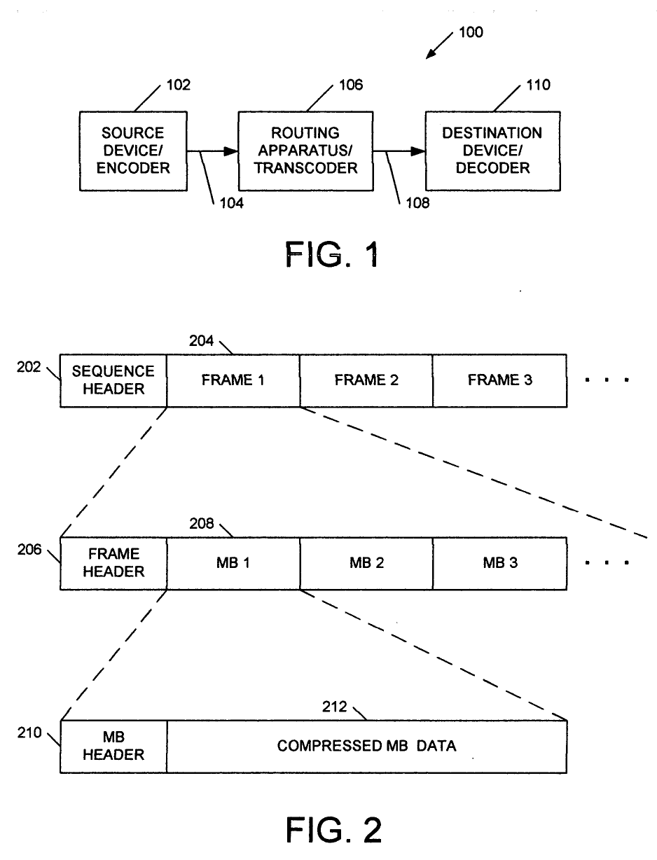

FIG. 1 is a simplified block diagram of an image data processing system 100, in accordance with an example embodiment. System 100 may be, for example, a video conferencing system. Although the terms “image” and “video” are both used in this description, it is to be understood that embodiments apply generally to transcoding “image” data, and accordingly anywhere the term “video” is used, it is to be understood that “video” data transcoding is just one example embodiment. Embodiments may apply both to single-image data transcoding and to multiple-image (e.g., video) data transcoding.

System 100 includes at least one source device/encoder 102, at least one routing apparatus/transcoder 106, and at least one destination device/decoder 110. Source device/encoder 102 may include, for example, a digital video camera capable of capturing and digitizing a series of images. A source device 102 may be associated with a video conferencing apparatus and/or a computer, for example. In such a system, source device/encoder 102 may compress and encode the digitized series of images using one or more of a variety of first video or image compression and encoding standards. In an embodiment, source device/encoder 102 produces “first” quantized, encoded video data 104. Source device 102 may also include a decoder and a display device, in an embodiment, to enable two-way video communications.

Source device/encoder 102 transmits the first quantized, encoded video data 104 to routing apparatus/transcoder 106. Transmission of the first quantized, encoded video data 104 may be through a direct connection or through a network (e.g., a local area network (LAN), a wide area network (WAN), or another type of network). The transmission path may include one or more wired or wireless links and one or more intermediate devices.

Routing apparatus/transcoder 106 receives the first quantized, encoded video data, and routes the data to one or more destination devices 110. Prior to routing the data, routing apparatus 106 may transcode the video or image data, based on resolution and decoding capabilities of the destination devices 110. For example, routing apparatus 106 may transcode the data from an MPEG-2 format to an H.264x format, if a destination device 110 is capable of decoding H.264x compressed data. Accordingly, routing apparatus 106 may produce “second” quantized, encoded video data 108.

Routing apparatus/transcoder 106 may route the second quantized, encoded video data to a destination device 110 through a direct connection or through a network (e.g., a LAN, a WAN, or another type of network). Again, the transmission path may include one or more wired or wireless links and one or more intermediate devices.

Destination device/decoder 110 receives the second quantized, encoded video data 108 and decodes and uncompresses the data according to the applicable standard. Destination device/decoder 110 may then display the image or video described by the uncompressed data, for example, on a display device. Destination device 110 may also include a camera and encoder, in an embodiment, to enable two-way video communications.

Various embodiments of transcoder apparatus and transcoding methods may be used in systems other than video conferencing systems. Further, various embodiments may be included or implemented in other types of apparatus, besides a routing apparatus (e.g., apparatus 106). For example, but not by way of limitation, various embodiments may be included or implemented in a video recording device (e.g., a digital video recorder), an image recording device (e.g., a digital camera), an encoding device, a decoding device, a transcoding device, a video or image display system or device (e.g., a computer, a portable or handheld communication or entertainment device, or a television, to name a few), a server computer, a client computer, and/or another type of general purpose or special purpose computer.

A basic understanding of the structure of an encoded video sequence may be helpful to understanding the described embodiments. Accordingly, FIG. 2 is provided, which is a diagram illustrating a layered structure of an encoded video sequence (e.g., an MPEG-encoded picture sequence).

At the highest layer, an encoded sequence structure includes a sequence header 202 and from one to many frame fields 204. Sequence header 202 may include information relevant to the entire encoded sequence, such as, for example, an encoding bitrate and a screen size (e.g., height and width in number of pixels), among other things.

Each frame field 204 may include encoding information relevant to an encoded frame (e.g., a picture in the sequence). Accordingly, at the next lower layer of the encoded sequence structure, sub-fields within a frame field 204 may include a frame header 206 and from one to many microblock (MB) fields 208.

For encoding and/or compression purposes, a picture may be divided into multiple microblocks, where a microblock includes a sub-block of pixels within a picture. For example, a picture may be divided so that the picture includes nine microblocks in the vertical direction, and sixteen microblocks in the horizontal direction, yielding a total of 144 microblocks that form the picture. Frame header 206 may include information relevant to all 144 compressed and encoded microblocks within the frame, such as, for example, a quantization factor and an indicator of a coding type (e.g., an intra-coding (spatial) type or an inter-coding (temporal) type), among other things.

A microblock field 208 may include a particular compressed microblock. Thus, at the lowest layer of the encoded sequence structure, sub-fields within a microblock field 208 may include a microblock header 210 and compressed microblock data 212. Microblock header 210 may include, for example, motion vector information and an indication of a microblock mode for the associated microblock, among other things. Each microblock may be compressed according to a different coding mode. Further, each microblock may be independently compressed or temporarily predicted. This type of information may be indicated by the microblock mode.

Microblock data field 212 includes the compressed data for a microblock. As indicated previously, microblock data 212 may be compressed using any of a number of image or video compression standards, including but not limited to MPEG 1/2/4, H.261x, H.263x, and H.264x, to name a few. In various embodiments, a transcoder may receive a sequence having microblocks that were compressed using a first standard, and may transcode the compressed microblocks into a format consistent with another standard. In a particular embodiment, a transcoder apparatus receives image data compressed and encoded according to MPEG 1/2/4, H.261x, H.263x, or another standard that results in quantized, n-tap, DCT blocks, and without performing full decode and re-encode processes, transcodes the data according to a standard that results in quantized, m-tap integer transform blocks.

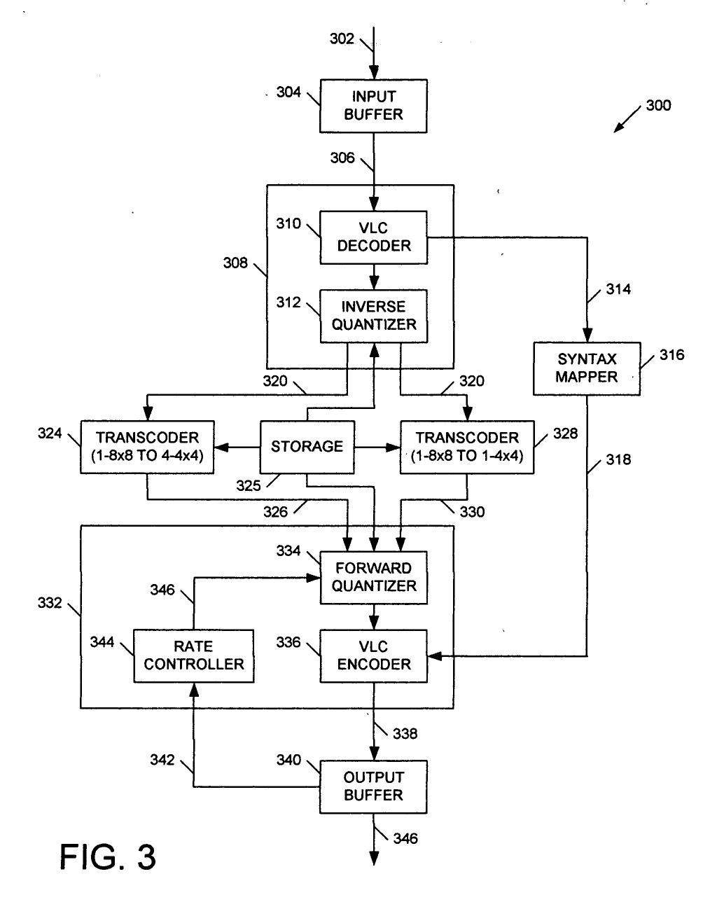

FIG. 3 is a simplified block diagram of an image data transcoder apparatus 300, in accordance with an example embodiment. Image data transcoder includes an input buffer 304, a re-use decoder/inverse quantizer 308, one or more transcoding blocks 324, 328, a re-use encoder/quantizer 332, and an output buffer 340, in an embodiment.

Transcoding according to various embodiments begins when an encoded image or video bitstream 302 is received in input buffer 304. The bitstream 302 may be received, for example, from a local or remote video conferencing or other recording device. Alternatively, the bitstream 302 may be retrieved from one or more local or remote data storage devices. In an embodiment, the received bitstream 302 may have a structure such as that illustrated and described in conjunction with FIG. 2.

The buffered bitstream data 306 is received by re-use decoder/inverse quantizer 308. In an embodiment, re-use decoder/inverse quantizer 308 includes a variable length coding (VLC) decoder 310 and an inverse quantizer 312. VLC decoder 310 decodes the bitstream data, to produce blocks of quantized, compressed image data.

In an embodiment, VLC decoder 310 also extracts syntax information, which may be re-used as will be described later, from one or more of the various headers (e.g., sequence header 202, frame header 206, MB header 210, FIG. 2) within the bitstream 306. Syntax information may include, for example, an encoding bitrate, screen size, quantization factors, coding types, motion vector information, and microblock modes, among other things.

In an embodiment, VLC decoder 310 passes the extracted syntax information 314 to syntax mapper 316. As will be described in more detail later, in conjunction with block 336, syntax mapper 316 may provide the syntax information 318 at appropriate times to a VLC encoder 336, so that the syntax information may be re-inserted (i.e., re-used) in a re-encoded bitstream. By extracting syntax information 314 prior to transcoding, and re-mapping the syntax information 318 into the bitstream after transcoding, re-computation of the syntax information for the re-encoded bitstream may be avoided. Accordingly, the re-use of the syntax information, such as motion vectors and the macroblock coding modes, for example, may conserve computing resources and may result in a more efficient transcoding process.

VLC decoder 310 also passes the quantized, compressed image data (e.g., compressed microblock data 212, FIG. 2) to inverse quantizer 312. In an embodiment, the quantized, compressed image data includes quantized, 8×8 (8-tap) DCT blocks, which are consistent with data compressed using MPEG 1/2/4, H.261x, and H.263x. Inverse quantizer 312 multiplies the quantized, compressed image data by the quantization factor that was used during the encoding process, in an embodiment. In a further embodiment, which will be described in more detail later, inverse quantizer 312 may apply one more transcoding matrices (e.g., D₈, described later), stored in storage 325, to perform a first portion of a transcoding operation. This results in inverse-quantized, 8×8 DCT blocks 320, in an embodiment.

The inverse-quantized, 8×8 DCT blocks may then be transcoded using either of two transcoding operations 324, 328, in an embodiment. Both transcoding operations 324, 328 may use one or more transcoding matrices, stored in data storage 325, to produce one or more 4×4 (4-tap) TCMs, in an embodiment. A first transcoding operation 324 produces four 4×4 TCMs 326 from each input 8×8 DCT block 320. A second transcoding operation 328 produces one 4×4 TCM 330 from each input 8×8 DCT block 320. Accordingly, the second transcoding operation 328 may be used when resolution reduction (i.e., screen size reduction) is desired, and the first transcoding operation 324 may be used when resolution reduction is not desired. The mathematical details of the transcoding operations 324, 328 are discussed in detail later.

The output 4×4 TCMs 326 or 330 are received by re-use encoder/forward quantizer 332. In an embodiment, re-use encoder/forward quantizer 332 includes a forward quantizer 334, a VLC encoder 336, and a rate controller 344. Forward quantizer 334 receives the 4×4 TCMs 326 or 330, and quantizes the blocks by multiplying them by a quantization factor. In a further embodiment, which will be described in more detail later, forward quantizer 334 may apply one more transcoding matrices (e.g., D₄), stored in storage 325, to perform a last portion of a transcoding operation.

In an embodiment, the selected quantization factor may be used to perform “rate shaping” or “rate adaptation” for the output data. In an embodiment, the desired output data rate may be detected based on the quantity of data queued within an output buffer 340. When the output buffer 340 is approaching an overrun situation, the quantization factor may be adjusted to increase the compression ratio. Conversely, when the output buffer 340 is depleting, the quantization factor may be adjusted to reduce the compression ratio. Forward quantizer 334 produces quantized, 4×4 TCMs, consistent with H.264x standard compression and encoding.

VLC encoder 336 receives the quantized, 4×4 TCMs and the syntax information 318 from syntax mapper 316. VLC encoder 336 then re-creates an encoded bitstream structure, and outputs the bitstream 338 to output buffer 340. Output buffer 340 provides feedback 342 to rate controller 344, indicating a status of the output buffer 340. Based on the feedback 342, rate controller 344, in turn, provides control information 346 to forward quantizer 334. For example, control information 346 may include a quantization factor, which is calculated to attempt to avoid depleting or overrunning the output buffer 340.

Output buffer 340 also outputs the queued bitstream 346. In an embodiment, the bitstream 346 may be routed over a network or other connection to a remote device (e.g., destination device 110, FIG. 1), for decoding, expansion, display, and/or storage. Alternatively, the bitstream 346 may be decoded, expanded, displayed, and/or stored by apparatus local to transcoder 300.

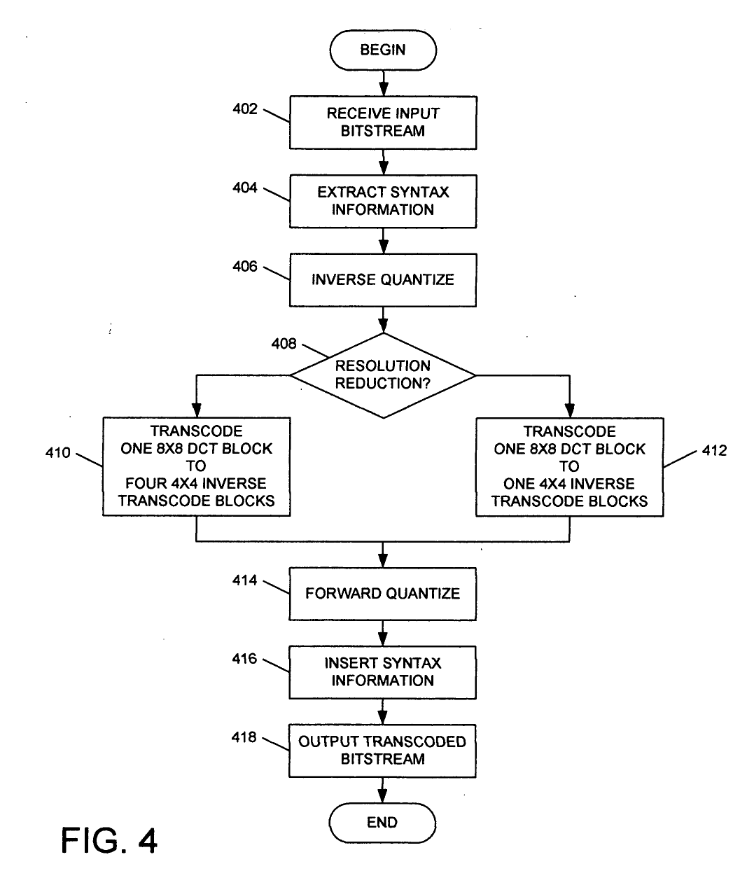

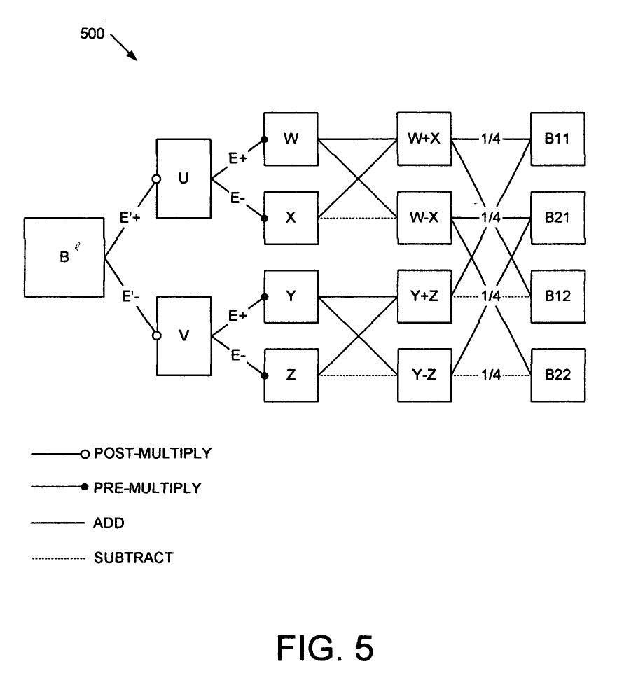

FIGS. 4 and 5 illustrate embodiments of a transcoding operation to transcode from one 8-tap DCT block to four 4-tap TCMs (e.g., transcode 1-8×8 to 4-4×4 block 324, FIG. 3) or to one 4-tap TCM (e.g., transcode 1-8×8 to 1-4×4 block 328, FIG. 3). Accordingly, the transcoding operations of the various embodiments enable encoded image data compressed using an MPEG 1/2/4, H.261x or H.263x standard to be transcoded to a format compatible with an H.264x or MPEG-4-AVC standard, without performing full decode and full re-encode processes.

In various embodiments, transcoding operations seek to re-use encoded information that resides in conjunction with the input objects (e.g., the 8×8 DCT blocks). In addition, in various embodiments, transcoding operations may utilize computationally simple integer operations (e.g., additions and subtractions) in the transcoding process, while avoiding extensive use or more computationally complex operations (e.g., floating-point operations such as multiplications and divisions).

FIG. 4 is a flowchart of a method for transcoding image data, in accordance with an example embodiment. More specifically, the method illustrated in FIG. 4 may be used to transcode an 8×8 DCT block into four 4×4 TCMs or into one 4×4 TCM. In an embodiment, transcoding according to the method of FIG. 4 applies to transcoding of inter-macroblocks. Variations of the embodiment described in conjunction with FIG. 4 may be used to transcode intra-frames or intra-macroblocks in inter-frames, as would be apparent to one of skill in the art, based on the description herein. For example, transcoding intra-frames or intra-macroblocks may include a full decode (e.g., MPEG 1/2/4 or MPEG-like) followed by a full encode (e.g., H.264x) process, in various embodiments.

The method begins, in block 402, by receiving an input bitstream containing one or more encoded image objects (e.g., video objects). In an embodiment, an encoded image object may include an 8×8 DCT block. In block 404, syntax information is extracted from the input bitstream. Syntax information may include, for example, but not by way of limitation, an encoding bitrate, screen size, quantization factors, coding types, motion vector information, and microblock modes, among other things.

In block 406, each 8×8 DCT block may be inverse quantized. In an embodiment, this includes multiplying a DCT block by an inverse of the quantization factor used to quantize the DCT block. This process may produce inverse-quantized DCT blocks.

A determination is made, in block 408, whether resolution reduction (e.g., screen size reduction) is to be applied to the inverse quantized DCT blocks. If not, then a first transcoding operation is performed, in block 410, in which each 8×8 DCT block (e.g., a block compatible with MPEG 1/2/4, H.261x, and H.263x encoding) is transcoded into four 4×4 TCMs (e.g., a block compatible with H.264x encoding). Mathematical operations for transcoding the 8×8 DCT blocks without resolution reduction are described in more detail below. If resolution reduction is to be applied, then a second transcoding operation is performed, in block 412, in which each 8×8 DCT block is transcoded into one 4×4 TCM. Again, mathematical operations for transcoding the 8×8 DCT blocks with resolution reduction are described in more detail below.

After transcoding, the resulting 4×4 TCMs are forward quantized, in block 414. In an embodiment, the quantization factors applied to the blocks may depend on the status of the output buffer, as previously described. In other embodiments, the quantization factors may depend on additional or different factors.

In block 416, all or portions of the previously-extracted syntax information are re-inserted or re-encoded into the bitstream. For example, previously-extracted motion vectors may be reinserted in bitstream locations that correspond to the original blocks to which the motion vectors applied. Other syntax information may similarly be inserted into bitstream locations that correspond with the syntax information's previous locations. Accordingly, syntax information is re-inserted in a manner that is synchronized with the transcoded TCMs in the output bitstream.

The transcoded, quantized bitstream is then output, in block 418. In an embodiment, the bitstream is output through an output buffer. The bitstream information within the buffer may then be transmitted to another computer, stored, and/or consumed by the apparatus that performed the transcoding. The method then ends.

Although FIG. 4 illustrates various processes as occurring in a specific sequence, it would be apparent to one of skill in the art that the order of the process blocks could be modified while still achieving the same results. Accordingly, modifications in the sequence of processing blocks are intended to fall within the scope of the disclosed subject matter.

Details of the transform operations will now be given in some detail. First, embodiment details relating to transcoding from an 8×8 DCT block to four 4×4 TCMs are discussed. Second, embodiment details relating to transcoding from an 8×8 DCT block to one 4×4 TCM are discussed.

Transcoding From One 8×8 DCT Block to Four 4×4 TCMs:

Considering the 8×8 DCT block, B, it may be reconstructed using an 8×8 inverse DCT as follows:
\hat{b}=T₈BT₈, (1)
where T₈ is the 8-tap DCT matrix. Block \hat{b} includes four 4×4 blocks \hat{b}₁₁, \hat{b}₁₂, \hat{b}₂₁, and \hat{b}₂₂ in the order of left to right and top to bottom. Each 4×4 block can be derived from the 8×8 block through a pair of matrix multiplications:
\hat{b}ᵢⱼ=eᵢ\hat{b}e′ⱼ, (2)
where e₁ and e₂ are 4×8 matrices that are defined as the upper and lower half of an 8×8 identity matrix, respectively.

To produce 4×4 TCMs for H.264x, a 4-tap transformation may be applied:
\hat{B}ᵢⱼ=T₄\hat{b}ᵢⱼT′₄, (3)
where T₄ may be a 4-tap integer transform as defined in the H.264x standard.

Combining Eqs (1), (2), and (3), results in:
\hat{B}_{ij=T}₄eᵢT′₈BT₈eⱼT′₄. (4)
Denoting
Eᵢ=T₄eᵢT′₈ , (5)
results in
\hat{B}ᵢⱼ=EᵢBE′ⱼ. (6)
After some manipulations, \hat{B}ᵢⱼ can be computed as follows:
\hat{B}₁₁=(W+X+Y+Z)/4 (7a)
\hat{B}₁₂=(W+X−Y−Z)/4 (7b)
\hat{B}₂₁=(W−X+Y−Z)/4 (7c)
\hat{B}₂₂=(W−X−Y+Z)/4, (7d)
where
W=E₊BE′₊ (8a)
X=E₋BE′₊ (8b)
Y=E₊BE′₋ (8c)
Z=E₋BE′₋, (8d)
and
E₊=E₁+E₂ (9a)
E₋=E₁−E₂. (9b)
Eqs. (8) can be efficiently computed by denoting
U=BE′₊ (10a)
V=BE′₋, (10b)
and then:
W=E₊U (11a)
X=E₋U (11b)
Y=E₊V (11c)
Z=E₋V. (11d)

FIG. 5 is a block diagram illustrating a one 8×8 DCT block to four 4×4 TCM transcoding operation 500, in accordance with an example embodiment. The complexities of the post-and pre-matrix multiplications shown in FIG. 5 are explored below. Based on Eqs. (5) and (9), E₊ and E₋ are computed as:

$$\begin{matrix}{E}_{+} = ( \begin{matrix}\sqrt{2} & 0 & 0 & 0 & 0 & 0 & 0 & 0 \\ 0 & 0.5842 & 0 & 1.1257 & 0 & - 0.5463 & 0 & 0.3051 \\ 0 & 0 & 0 & 0 & \sqrt{2} & 0 & 0 & 0 \\ 0 & 0.0740 & 0 & - 0.0583 & 0 & 0.6564 & 0 & 1.2491\end{matrix} ) & ( 12 ) \\ {E}_{-} = ( \begin{matrix}0 & 1.2815 & 0 & - 0.4500 & 0 & 0.3007 & 0 & - 0.2549 \\ 0 & 0 & 1.4107 & 0 & 0 & 0 & - 0.1003 & 0 \\ 0 & - 0.1056 & 0 & 0.7259 & 0 & 1.0864 & 0 & - 0.5308 \\ 0 & 0 & 0.1003 & 0 & 0 & 0 & 1.4107 & 0\end{matrix} ) . & ( 13 )\end{matrix}$$

Due to the manipulations from Eq. (7) to Eq. (11) taking advantage of the symmetric property of the transformations, many entries in E₊ and E₋ are zero, which reduces the transcoding complexity significantly. However, each matrix still contains at least 10 non-trivial elements, which causes one matrix multiplication (8×4 with 4×4) to have at least 40 multiplications. To reduce this complexity, an approach based on a factorization of the transformation matrix may be used, in an embodiment. The factorization is considered along with the 4-tap integer transform used in H.264x. Specifically, the 8-tap DCT matrix, T₈, may be factorized as follows:
T₈=D₈PB₁B₂MA₁A₂A₃. (14)

On the other hand, the 4-tap integer transform used in H.264x, T₄, is also factorized into a diagonal matrix and an integer transformation matrix:

$${T}_{4} = {D}_{4} C = ( \begin{matrix}a & & & \\ & b & & \\ & & a & \\ & & & b\end{matrix} ) ( \begin{matrix}1 & 1 & 1 & 1 \\ 1 & d & - d & - 1 \\ 1 & - 1 & - 1 & 1 \\ d & - 1 & - 1 & - d\end{matrix} ) , \qquad ( 15 )$$

where a=½, b={square root over (⅖ and d=½. It represents an integer orthogonal approximation to the 4-tap DCT.

Plugging Eq. (14) and (15) into Eq. (5) and then Eq. (9), results in the factorized version of E₊and E₋:

$$\begin{matrix}{E}_{+} = {D}_{4} \overbrace{C ( {e}_{1} + {e}_{2} ) {A}_{3}^{′} {A}_{2}^{′} {A}_{1}^{′} {M}^{′}} {B}_{2}^{′} {B}_{1}^{′} P {D}_{8} & ( 16 a ) \\ {E}_{-} = {D}_{4} \underbrace{C ( {e}_{1} - {e}_{2} ) {A}_{3}^{′} {A}_{2}^{′} {A}_{1}^{′} {M}^{′}} {B}_{2}^{′} {B}_{1}^{′} P {D}_{8} . & ( 16 b )\end{matrix}$$

From this sequence of matrix multiplications, the products of the matrices within the under and over braces may render sparse matrices, in an embodiment. In other embodiments, other combinations may be used to render sparse matrices. In an embodiment, denoting:
E₊^{d}=C(e₁+e₂)A′₃A′₂A′₁M (17a)
E₋^{d}=C(e₁−e₂)A′₃A′₂A′₁M′, (17b)
results in
E₊=D₄E₊^{d}B′₂B′₁PD₈ (18a)
E₋=D₄E₋^{d}B′₂B′₁PD₈. (18b)

The matrix multiplication with transcoding matrices E₊ or E₋ may now be carried out with transcoding matrix D₄ absorbed in the forward quantization (e.g., forward quantizer 334, FIG. 3) as already defined in H.264x, and transcoding matrix D₈ absorbed in the inverse quantization (e.g., inverse quantizer 312, FIG. 3). The matrix multiplications with P, B′₂, and B′₁ may contain trivial operations. Therefore, E₊^{d} and E₋^{d} may be the primary matrices that contain non-trivial elements, as shown in the following:

$$\begin{matrix}{E}_{+}^{d} = ( \begin{matrix}8 & 0 & 0 & 0 & 0 & 0 & 0 & 0 \\ 0 & 0 & 0 & 0 & - 3.9197 & 0 & 1.6236 & 2 \\ 0 & 8 & 0 & 0 & 0 & 0 & 0 & 0 \\ 0 & 0 & 0 & 0 & 1.3066 & 0 & - 0.5412 & 1\end{matrix} ) & ( 19 a ) \\ {E}_{-}^{d} = ( \begin{matrix}0 & 0 & 0 & 0 & 2.1648 & 2 \sqrt{2} & 5.2263 & 2 \\ 0 & 0 & 4.2426 & 4 & 0 & 0 & 0 & 0 \\ 0 & 0 & 0 & 0 & 0 & - 2 \sqrt{2} & 0 & 2 \\ 0 & 0 & - \sqrt{2} & 1 & 0 & 0 & 0 & 0\end{matrix} ) . & ( 19 b )\end{matrix}$$

Note that there are eight non-zero coefficients in E₊^{d} (among them five are non-trivial, and ten non-zero coefficients in E₋^{d} (among them six are non-trivial).

The computation complexity may be further reduced, in an embodiment, by using basic integer operations (e.g., shift and/or add) to replace multiplications. Specifically, the fractional numbers may be represented using 8-bit 2's complement format. Allowing at most one shift to replace a floating-point multiplication (1s approximation), E₊^{d} and E₋^{d} may be approximated as:

$$\begin{matrix}{E}_{+}^{d} = ( \begin{matrix}8 & 0 & 0 & 0 & 0 & 0 & 0 & 0 \\ 0 & 0 & 0 & 0 & - 4 & 0 & 2 & 2 \\ 0 & 8 & 0 & 0 & 0 & 0 & 0 & 0 \\ 0 & 0 & 0 & 0 & 1 & 0 & - 0.5 & 1\end{matrix} ) & ( 20 a ) \\ {E}_{-}^{d} = ( \begin{matrix}0 & 0 & 0 & 0 & 2 & 2 & 4 & 2 \\ 0 & 0 & 4 & 4 & 0 & 0 & 0 & 0 \\ 0 & 0 & 0 & 0 & 0 & - 2 & 0 & 2 \\ 0 & 0 & - 1 & 1 & 0 & 0 & 0 & 0\end{matrix} ) . & ( 20 b )\end{matrix}$$

Alternatively, at most two shifts and two additions may be allowed for each approximation to achieve higher precision (2s2a):

$$\begin{matrix}{E}_{+}^{d} = ( \begin{matrix}8 & 0 & 0 & 0 & 0 & 0 & 0 & 0 \\ 0 & 0 & 0 & 0 & - 4 & 0 & 1.625 & 2 \\ 0 & 8 & 0 & 0 & 0 & 0 & 0 & 0 \\ 0 & 0 & 0 & 0 & 1.25 & 0 & - 0.5 & 1\end{matrix} ) & ( 21 a ) \\ {E}_{-}^{d} = ( \begin{matrix}0 & 0 & 0 & 0 & 2.125 & 2.5 & 5.25 & 2 \\ 0 & 0 & 4.25 & 4 & 0 & 0 & 0 & 0 \\ 0 & 0 & 0 & 0 & 0 & - 2.5 & 0 & 2 \\ 0 & 0 & - 1.5 & 1 & 0 & 0 & 0 & 0\end{matrix} ) . & ( 21 b )\end{matrix}$$

Using Eq. (20) or (21) for the matrix multiplications with E₊ and E₋, as shown in FIG. 5, offers an integer transcoding solution that is highly efficient, when compared to a re-encoding approach. ps Transcoding From One 8×8 DCT Block to One 4×4 TCM:

To produce a 4-tap TCM from an 8-tap DCT block, an embodiment produces B₄ by extracting the low-pass band of the 8-tap DCT input block, B₈ (i.e., the most significant (upper left) 4×4 sub-block within the 8×8 DCT block).

The inverse DCT of the 4×4 low-pass coefficients truncated from an 8×8 block provides a low-pass filtered version. However, H.264x uses a 4-tap integer transformation, and accordingly the truncating approach may not generate sufficiently precise transcoding results. Accordingly, in an embodiment, B₄ is multiplied by a scale factor, and the result is used as an H.264x transform block. In an embodiment, scaling is performed by right shifting each coefficient in B₄ by one bit. In another embodiment, scaling may be performed by applying the following to the 4-tap low-pass band, B₄, which is truncated from the 8-tap DCT input, B₈:
\hat{B}₄=A′B₄A, (22)
where

$$A = ( \begin{matrix}1 & 0 & 0 & 0 \\ 0 & 0.9975 & 0 & 0.0709 \\ 0 & 0 & 1 & 0 \\ 0 & - 0.0709 & 0 & 0.9975\end{matrix} ) . \qquad ( 23 )$$

\hat{B}₄ can then be used as an H.264x transform block. Note that A is almost an identity matrix, which also indicates that the H.264x integer transformation is very similar to DCT.

In one case, the adjustment may be bypassed. In particular, the adjustment may be bypassed when B₄ contains all zero coefficients in the 2^{nd} and 4^{th} row and column. In general, to avoid non-trivial multiplications, A may be approximated as an identity matrix. Therefore, B₄ may be approximately used as an H.264x transform block without the adjustment. The approximation may results in an integer transcoding with some degradation in quality. Following a coarser quantization for bit rate reduction, this degradation may not be significant.

The various procedures described herein can be implemented in combinations of hardware, firmware, and/or software. Portions implemented in software could use microcode, assembly language code or a higher-level language code. The code may be stored on one or more volatile or non-volatile computer-readable media during execution or at other times. These computer-readable media may include hard disks, removable magnetic disks, removable optical disks, magnetic cartridges or cassettes, flash memory cards, digital video disks, Bernoulli cartridges, RAMs, ROMs, and the like.

Thus, various embodiments of image data transcoding apparatus and methods have been described. The foregoing description of specific embodiments reveals the general nature of the inventive subject matter sufficiently that others can, by applying current knowledge, readily modify and/or adapt it for various applications without departing from the general concept. Therefore, such adaptations and modifications are within the meaning and range of equivalents of the disclosed embodiments. For example, although certain standards have been discussed herein, embodiments of the disclosed subject matter may also apply to transcoding applied to or producing image data encoded in other standards, as well, including standards currently under development and adoption, and standards that may be developed and adopted after the issue date of this patent.

The phraseology or terminology employed herein is for the purpose of description and not of limitation. Accordingly, the disclosed subject matter embraces all such alternatives, modifications, equivalents and variations as fall within the spirit and broad scope of the appended claims.

What is claimed is:

1. An apparatus comprising:
a transcoder to combine an inverse-quantized DCT (discrete cosine transform) block, which represents image data compressed according to a first compression standard, with one or more transcoding matrices, resulting in one or more transform coefficient matrices (TCMs), which represent image data that is expandable according to a second compression standard.

2. The apparatus of claim 1, wherein the inverse-quantized DCT block includes an 8×8 DCT block having a format consistent with a compression standard selected from a group of standards that includes Motion Pictures Experts Group (MPEG) version 1, MPEG version 2, MPEG version 4, an H.261 standard, and an H.263 standard.

3. The apparatus of claim 1, wherein the inverse-quantized DCT block includes an 8×8 DCT block, and wherein the transcoder is to produce four 4×4 TCMs by combining the 8×8 DCT block with the one or more transcoding matrices.

4. The apparatus of claim 1, wherein the inverse-quantized DCT block includes an 8×8 DCT block, and wherein the transcoder is a resolution reduction transcoder to produce one 4×4 TCM by combining the 8×8 DCT block with the one or more transcoding matrices.

5. The apparatus of claim 1, wherein the one or more TCMs include a 4×4 coefficient matrix having a format consistent with a compression standard selected from a group of standards that includes an H.264 standard and Motion Pictures Experts Group (MPEG) version 4, AVC (MPEG-4-AVC).

6. The apparatus of claim 1, further comprising:
a decoder to decode an input bitstream, resulting in a quantized DCT block, wherein the decoder is further to extract syntax information from the input bitstream; and
an inverse quantizer to inverse quantize the quantized DCT block, resulting in the inverse-quantized DCT block.

7. The apparatus of claim 6, wherein the syntax information extracted from the input bitstream includes one or more motion vectors.

8. The apparatus of claim 6, wherein the syntax information extracted from the input bitstream includes one or more block coding modes.

9. The apparatus of claim 6, wherein the inverse quantizer is further to apply one or more first transform coefficient matrices to the quantized DCT block.

10. The apparatus of claim 1, further comprising:
a forward quantizer to quantize the one or more TCMs, resulting in one or more quantized TCMs; and
an encoder to encode the one or more quantized TCMs, and to produce an output bitstream.

11. The apparatus of claim 10, wherein the forward quantizer is further to apply one or more last transform coefficient matrices to the one or more TCMs.

12. The apparatus of claim 10, further comprising:
an output buffer to store the output bitstream; and
a rate controller to provide control information to the forward quantizer based on a status of the output buffer, and wherein the forward quantizer is further to apply quantization factors based on the control information.

13. An apparatus comprising:
means for inverse quantizing a quantized DCT (discrete cosine transform) block, which represents image data compressed according to a first compression standard, resulting in an inverse-quantized DCT block; and
means for combining the inverse-quantized DCT block with one or more transcoding matrices, resulting in one or more transform coefficient matrices (TCMs), which represent image data that is expandable according to a second compression standard.

14. The apparatus of claim 13, wherein the inverse-quantized DCT block includes an 8×8 DCT block having a format consistent with a compression standard selected from a group of standards that includes Motion Pictures Experts Group (MPEG) version 1, MPEG version 2, MPEG version 4, an H.261 standard, and an H.263 standard.

15. The apparatus of claim 13, wherein the one or more TCMs include a 4×4 coefficient matrix having a format consistent with a compression standard selected from a group of standards that includes an H.264 standard and Motion Pictures Experts Group (MPEG) version 4, AVC (MPEG-4-AVC).

16. An apparatus comprising:
a transcoder to combine an inverse-quantized DCT (discrete cosine transform) block, which represents image data compressed according to a first compression standard, with one or more transcoding matrices, resulting in one or more transform coefficient matrices (TCMs), which represent image data that is expandable according to a second compression standard,
wherein the inverse-quantized DCT block includes an 8×8 DCT block having a format consistent with a compression standard selected from a group of standards that includes Motion Pictures Experts Group (MPEG) version 1, MPEG version 2, MPEG version 4, an H.261 standard, and an H.263 standard, and
wherein the one or more TCMs include a 4×4 coefficient matrix having a format consistent with a compression standard selected from a group of standards that includes an H.264 standard and Motion Pictures Experts Group (MPEG) version 4, AVC (MPEG-4-AVC), and
wherein the one or more transcoding matrices include values that enable the one or more transcoding matrices to be combined with the inverse-quantized DCT block using integer operations rather than floating-point operations.

17. The apparatus of claim 16, wherein the inverse-quantized DCT block includes an 8×8 DCT block, and wherein the transcoder is to produce four 4×4 TCMs by combining the 8×8 DCT block with the one or more transcoding matrices.

18. The apparatus of claim 16, wherein the inverse-quantized DCT block includes an 8×8 DCT block, and wherein the transcoder is a resolution reduction transcoder to produce one 4×4 TCM by combining the 8×8 DCT block with the one or more transcoding matrices.

19. A method comprising:
combining a DCT (discrete cosine transform) block, which represents image data compressed according to a first compression standard, with one or more transcoding matrices, resulting in one or more transform coefficient matrices (TCMs), which represent image data that is expandable according to a second compression standard.

20. The method of claim 19, wherein the DCT block includes an 8×8 DCT block having a format consistent with a first compression standard selected from a group of standards that includes Motion Pictures Experts Group (MPEG) version 1, MPEG version 2, MPEG version 4, an H.261 standard, and an H.263 standard.

21. The method of claim 19, wherein the one or more TCMs include a 4×4 coefficient matrix having a format consistent with a second compression standard selected from a group of standards that includes an H.264 standard and Motion Pictures Experts Group (MPEG) version 4, AVC (MPEG-4-AVC).

22. The method of claim 19, wherein the DCT block includes an 8×8 DCT block, and wherein combining includes producing four 4×4 TCMs by combining the 8×8 DCT block with the one or more transcoding matrices.

23. The method of claim 19, wherein the DCT block includes an 8×8 DCT block, and wherein the combining includes producing one 4×4 TCM by combining the 8×8 DCT block with the one or more transcoding matrices, resulting in a resolution reduction.

24. The method of claim 19, further comprising:
extracting syntax information from the input bitstream; and
inserting the syntax information into an output bitstream.

25. The method of claim 19, wherein the one or more transcoding matrices include values that enable the one or more transcoding matrices to be combined with the inverse-quantized DCT block using integer operations, and wherein combining comprises performing integer operations.

26. A computer readable medium having program instructions stored thereon to perform a method, which when executed result in:
transcoding an inverse-quantized DCT (discrete cosine transform) block, which represents image data compressed according to a first compression standard, by combining the inverse-quantized DCT block with one or more transcoding matrices, resulting in one or more transform coefficient matrices (TCMs), which represent image data that is expandable according to a second compression standard.

27. The computer readable medium of claim 26, wherein the inverse-quantized DCT block includes an 8×8 DCT block having a format consistent with a first compression standard selected from a group of standards that includes Motion Pictures Experts Group (MPEG) version 1, MPEG version 2, MPEG version 4, an H.261 standard, and an H.263 standard.

28. The computer readable medium of claim 26, wherein the one or more TCMs include a 4×4 coefficient matrix having a format consistent with a second compression standard selected from a group of standards that includes an H.264 standard and Motion Pictures Experts Group (MPEG) version 4, AVC (MPEG-4-AVC).

29. The computer readable medium of claim 26, wherein the inverse-quantized DCT block includes an 8×8 DCT block, and wherein transcoding includes producing four 4×4 TCMs by combining the 8×8 DCT block with the one or more transcoding matrices.

30. The computer readable medium of claim 26, wherein the inverse-quantized DCT block includes an 8×8 DCT block, and wherein the transcoding includes producing one 4×4 TCM by combining the 8×8 DCT block with the one or more transcoding matrices, resulting in a resolution reduction.
